(19) United States
(12) Patent Application Publication
(10) Pub. No.: US 2009/0300695 A1
(43) Pub. Date: Dec. 3, 2009

(54) SYSTEM AND METHOD OF IDENTIFYING EVENTS SCHEDULED AT A MEDIA RECORDER

(75) Inventors: SCOTT WHITE, AUSTIN, TX (US); SCOTT H. COOPER, MONTGOMERY, IL (US); JAMES L. CANSLER, JR., PFLUGERVILLE, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T KNOWLEDGE VENTURES, L.P., Reno, NV (US)

(21) Appl. No.: 12/129,435

(22) Filed: May 29, 2008

(51) Int. Cl. H04N 7/173; H04N 5/445

(52) U.S. Cl. 725/109; 725/58

(57) ABSTRACT

A system and method of identifying events scheduled at a media recorder. In a particular embodiment, a system to identify events scheduled at a media recorder is disclosed. The system includes an identification module to determine a time interval and an address and to identify one or more media content items scheduled for recording within the time interval. The system also includes a notification module to send a message to the address, the message including scheduling information related to the one or more media content items scheduled for recording within the time interval.

### FIELD OF THE DISCLOSURE

The present disclosure is generally related to identifying events scheduled at a media recorder.

### BACKGROUND

Subscribers may use a media recorder, such as a digital video recorder or set-top box, to record media content broadcast by a media content provider. For example, a subscriber may program the media recorder to record media content before the media content is scheduled for delivery. To illustrate, the subscriber may program the media recorder to record a television program at the same day and same time each week. The subscriber may also program the media recorder in advance to record a single event, such as a live sporting event. If the subscriber is at a location different than the media recorder, the subscriber may not be able to determine the events, such as recordings, that are scheduled to take place at the media recorder during a particular time interval. For example, while at work, the subscriber may not be able to determine which media content is scheduled for recording within the next twenty-four hours.

### BRIEF DESCRIPTION OF THE DRAWINGS

FIG. 1 is a block diagram illustrating a particular embodiment of a system to identify events scheduled at a media recorder;

FIG. 2 is an illustrative embodiment of a graphical user interface display that may be displayed to a user of a media recorder, such as a media recorder in FIG. 1;

FIG. 3 is a flow diagram of a first particular embodiment of a method of identifying events scheduled at a media recorder, such as a media recorder in FIG. 1;

FIG. 4 is a flow diagram of a second particular embodiment of a method of identifying events scheduled at a media recorder, such as a media recorder in FIG. 1;

FIG. 5 is a flow diagram of a third particular embodiment of a method of identifying events scheduled at a media recorder, such as a media recorder in FIG. 1;

FIG. 6 is a flow diagram of a fourth particular embodiment of a method of identifying events scheduled at a media recorder, such as a media recorder in FIG. 1; and

FIG. 7 is a block diagram of an illustrative embodiment of a general computer system.

### DETAILED DESCRIPTION

In a particular embodiment, a system to identify events scheduled at a media recorder is disclosed. The system includes an identification module to determine a time interval and an address and to identify one or more media content items scheduled for recording within the time interval. The system also includes a notification module to send a message to the address, the message including scheduling information related to the one or more media content items scheduled for recording within the time interval.

In another embodiment, a method of identifying events scheduled at a media recorder includes identifying one or more recordings scheduled to occur at the media recorder within a particular time interval. The method includes creating a message including scheduling information related to the one or more recordings. The method also includes sending the message including the scheduling information to a network address, where the network address is associated with a network device that is remote from the media recorder.

In another embodiment, a method includes receiving a first message at a notification server. The message identifies one or more events scheduled to occur at a media recorder within a time interval based on a schedule of events. The method includes creating a second message including information about the one or more events. The method also includes sending the second message to an address associated with a user of the media recorder.

In another embodiment, a graphical user interface display at a portable communication device is disclosed. The graphical user interface display includes a scheduled event display area to display one or more recordings scheduled to occur at a media recorder within a time interval based on a schedule of events at the media recorder. The media recorder is remote from the portable communication device.

In another embodiment, a computer-readable storage medium is disclosed. The computer-readable storage medium includes operational instructions, that when executed by a processor, cause the processor to determine a time interval, an address, and an event type. The event type includes a recording, a notification, and a media transfer. The computer-readable storage medium also includes operational instructions, that when executed by the processor, cause the processor to identify one or more events of the event type that are scheduled to occur within the time interval at the media recorder. The computer-readable storage medium also includes operational instructions, that when executed by the processor, cause the processor to send a message to the address. The message includes information related to the one or more events.

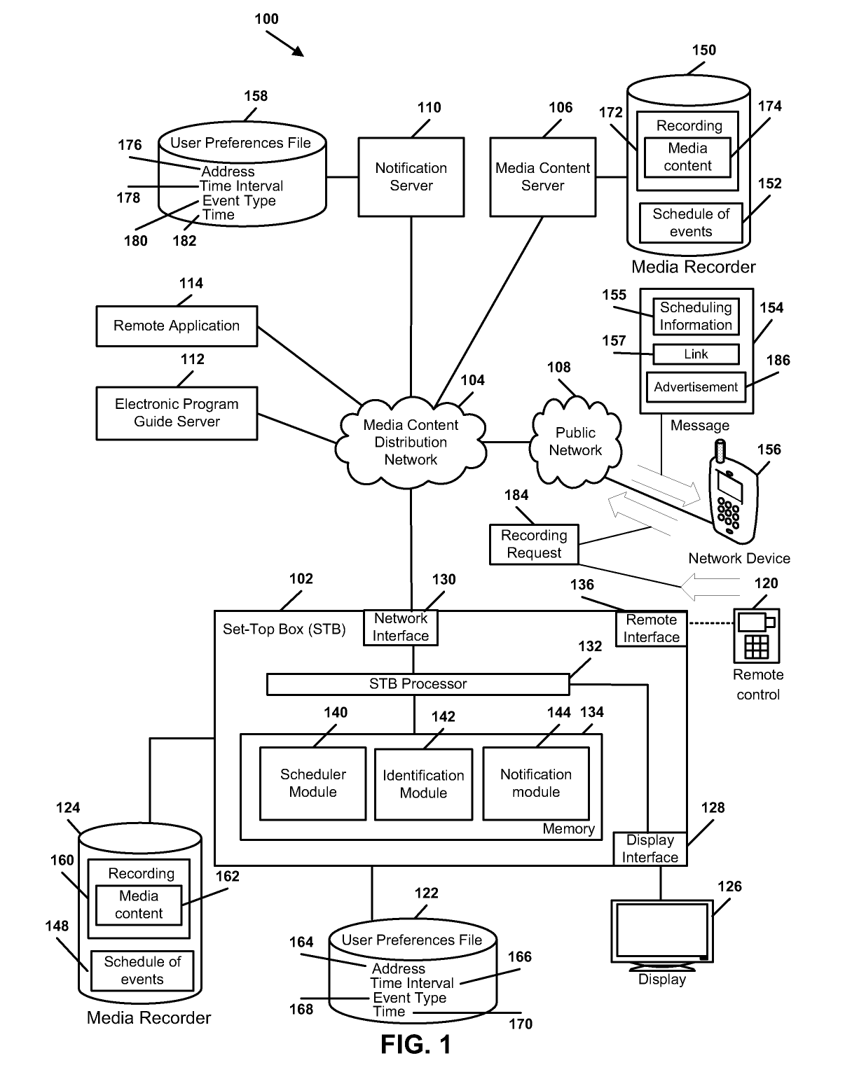

FIG. 1 is a block diagram illustrating a particular embodiment of a system 100 to identify events scheduled at a media recorder. In a particular embodiment, the system 100 includes a set-top box (STB) device 102 coupled to a media content distribution network 104 via a network interface 130. A media content server 106 is coupled to the media content distribution network 104. A media recorder 150 may be coupled to the media content server 106. A public network 108 is also coupled to the media content distribution network 104. Network devices, such as representative network devices 156 may be coupled to the public network 108. A notification server 110 is coupled to the media content distribution network 104. The notification server 110 may have access to a user preferences file 158. An electronic program guide server 112 is coupled to the media content distribution network 104. A remote application 114 is also coupled to the media content distribution network 104.

The media content distribution network 104 is a communications network adapted to distribute media content from a media content source to media receivers, such as set-top boxes. For example, the media content distribution network 104 may include a direct broadcast satellite (DBS) transmission network, an Internet Protocol (IP) based network, a hybrid fiber coax (HFC) network, or any combination thereof The media content distribution network 104 may distribute media content to one or more set-top boxes.

The media content server 106 is adapted to distribute content via the media content distribution network 104 to media receivers, such as the set-top box device 102. Media content distributed by the media content server 106 may include a television show, a movie, a video-on-demand program, music, a video game, other media content, or any combination thereof.

The media recorder 150 is adapted to record and playback media content. The media recorder 150 is also adapted to schedule recording of media content that is scheduled for transmission in the future. The media recorder 150 may be a network-based digital video recorder (DVR). The media recorder 150 includes a schedule of events 152. The schedule of events 152 is a listing of events scheduled to occur at the media recorder 150. Generally, an event may be any activity performed at a media recorder, such as a recording, a notification, or a media transfer. For example, a media content transmission may be scheduled for recording at the media recorder 150. A subscriber may schedule the media recorder 150 to notify the subscriber of a particular media content transmission to enable the subscriber to view the media content while the media content is being transmitted. A subscriber to one or more services of the system 100, such as a user of the STB device 102, may also schedule the transfer of a recording from one media to another media at the media recorder 150. For example, when the media recorder 150 has a disk drive and an optical recorder, the subscriber may schedule the transfer of a recording from the disk drive to an optical read-only memory (ROM). The media recorder 150 includes at least one recording 172. The recording 172 includes media content 174, such as a television show or video-on-demand program.

The public network 108 is a communications network that is adapted for access by the public. The public network 108 may be a telecommunications network, a data network such as the Internet, a wireless network, a wireline network, or any combination thereof.

The network device 156 is adapted to send and receive communications via a network, such as the public network 108. The network device 156 may be a computer, such as a desktop computer or a laptop computer or a portable communication device capable of connecting to a network, such as a wireless phone, a personal digital assistant (PDA), a portable music player, or any combination thereof. The network device 156 may receive a message 154, where the message includes scheduling information 155. The scheduling information 155 maybe related to one or more events schedule to occur at the media recorder 124 or 150.

The user preferences file 158 contains information related to sending the message 154 to a subscriber about events scheduled at a media recorder, such as the media recorder 150. The user preferences file 158 enables the subscriber to specify his or her preferences once, after which the subscriber's preferences may be periodically retrieved and, based on the retrieved preferences, the message 154 may be sent to the subscriber. For example, the user preferences file 158 may include an address 176, a time interval 178, an event type 180, a time 182, other user preference information, or any combination thereof. Typically, the message 154 is sent to the address 176 at the time 182 and contains information related to recordings scheduled within the time interval 178. The address 176 may be the network address of a network device, such as the network devices 154 and 156. The event type 180 may be used to classify each event. The event type 180 may correspond to one or more categories of events scheduled at a media recorder, such as a recording, a notification, a media transfer, one or more other types of actions capable of being performed by a media recorder, or any combination thereof. For example, when the event type 180 is a recording, the subscriber may be notified of the recordings scheduled at the media recorder 150. When the event type 180 is a notification, the subscriber may be notified of the notifications scheduled at the media recorder 150. When the event type 180 is a media transfer, the subscriber maybe notified of the media transfer scheduled at the media recorder 150.

The notification server 110 is adapted to determine information about events scheduled at the media recorder 150 based on the user preferences file 158. For example, the notification server 110 may identify recordings scheduled to occur within the time interval 178 at the media recorder 150. The notification server 110 may also send the message 154 including the scheduling information 155 about the number of events of the event type 180 occurring within the time interval 178 to a network device associated with a subscriber. For example, the notification server 110 may send the message 154 to the network device 156, where the message 154 includes scheduling information 155 that identifies the recordings scheduled to occur within a twenty-four hour time interval at the media recorder 150.

The electronic program guide server 112 may be adapted to provide information regarding media content scheduled for transmission by the media content server 106 via the media content distribution network 104. For example, the information stored at the electronic program guide server 112 may include the start time of a media content transmission, the end time of the media content transmission, the duration of the media content transmission, the broadcast channel of the media content transmission, information descriptive of the media content such as a title or synopsis, or any combination thereof.

The remote application 114 is adapted to control a media recorder via a network device. The remote application 114 may be an Internet-based application. For example, a subscriber may use the remote application 114 to modify events scheduled at the media recorder 150. The remote application 114 may enable the subscriber to use a network device, such as the network device 156, to modify the schedule of events 152.

The STB device 102 is configured to display media content received from the media content server 106 via the media content distribution network 104. The STB device 102 includes a STB processor 132 and a memory 134 accessible to the STB processor 132. The STB device 102 communicates with the media content distribution network 104 via the network interface 130. The STB processor 132 communicates media content to a display device 126 via a display interface 128. In addition, the STB processor 132 communicates with a remote control device 120 via a remote interface 136. A channel for receiving particular media content may be selected from an input device associated with the STB device 102, such as the remote control 120. The media content displayed may include a television show, a movie, a video-on-demand program, music video, a video game, other media content or any combination thereof. The STB device 102 may also communicate with a data storage device, such as the media recorder 124. For example, the media recorder 124 may be coupled to the set-top box device 102. In another example, the media recorder 124 may be integrated with the STB device 102.

In a particular embodiment, a user preferences file, such as the user preference file 122 or the user preferences file 158, may be accessible to the STB device 102. The user preferences file 122 may be stored at the memory 134 or at a remote network device, such as the notification server 110. The user preferences file 122 may include information associated with a subscriber, such as an address 164, and information associated with events scheduled for the subscriber, such as a time interval 166, an event type 168, and a time 170. The address 164 may specify where the message 154 is to be sent, such as a network address of the network device 156. The time interval 166 may specify a length or a range of time for which the subscriber wishes to be provided scheduling information, such as twenty-four hours. The event type 168 may specify the type of events the subscriber wishes to be notified of, such as recordings. The time 170 may identify the time at which subscriber prefers to receive a notification. For example, the subscriber may prefer to receive a notification message at 9:00 A.M. every day. The user preferences file 122 may also contain information identifying how to notify the subscriber, the format of the message sent to the subscriber, whether the subscriber wants to receive advertisements and coupons, other subscriber related preferences, or any combination thereof. The format of the message may identify the preferred format for the notification message. For example, the subscriber may prefer to receive the notification message in plain text format or in HyperText Markup Language (HTML) format. The user preferences file 122 may contain information identifying whether the subscriber prefers not to receive advertisements and coupons along with the notification message.

The media recorder 124 is coupled to or internal to the STB device 102. The media recorder 124 may include a schedule of events 148 listing events scheduled to take place at the media recorder 124 or at the media recorder 150. For example, an event maybe a recording 160 scheduled to occur at the media recorder 124, a transfer of the recording 160 from the media recorder 124 to another device, a notification scheduled to notify the subscriber of an upcoming media content broadcast, any other event which may occur at a media recorder, or any combination thereof. The recording 160 may include media content 162, such as a television show or video-on-demand program.

The memory 134 includes various modules to perform functions of the set-top box device 102. The various modules may be implemented in hardware, software, firmware, or any combination thereof. In a particular embodiment, the memory 134 includes a scheduler module 140, an identification module 142, and a notification module 144. The scheduler module 140 may include instructions executable by the STB processor 132 to receive a recording request 184. The recording request 184 may include a specified time to schedule a recording of media content. The recording of the media content may be scheduled at a media recorder, such as the media recorder 124 or the media recorder 150. The identification module 142 may include instructions executable by the STB processor 132 to identify one or more events in the schedule of events 148 that occur within a particular time interval. The notification module 144 may include instructions executable by the STB processor 132 to notify a subscriber of scheduled events at the media recorder 124 or the media recorder 150.

In a particular embodiment, the remote interface 136 is adapted to receive user input from the remote control device 120. In a particular embodiment, the STB device 102 is adapted to receive user input from other remote devices. For example, the network interface 130 includes instructions executable by the STB processor 132 to receive user input via the public network 108 from a network device, such as the representative network device 156. The user input may include a request that an event be added, modified or deleted to the schedule of events 148 or the schedule of events 152. The set-top box device 102 may be configured to receive the address 176, the time interval 178, and the event type 180 from the subscriber and to forward the address 176, the time interval 178, and the event type 180 to the notification server 110.

The scheduler module 140 may include instructions executable by the STB processor 132 to add, modify or delete an event. The event may be added, modified, or deleted from a schedule of events, such as the schedule of events 148 or the schedule of events 152. For example, the scheduler module 140 may update the schedule of events 148 based on input from the subscriber.

The identification module 142 may include instructions executable by the STB processor 132 to identify one or more events in the schedule of events 148 that occur within a particular time interval, such as the time interval 166 or 178. For example, when a subscriber requests the message 154 identifying events scheduled to occur at the media recorder 124 within the time interval 166, the identification module 142 may examine the schedule of events 148 and identify the events that are scheduled within the time interval 166. In a particular embodiment, the identification module 142 includes operational instructions that are executable by the STB processor 132 to retrieve the time interval 166 and the address 164 from the user preferences file 122 or to retrieve the time interval 178 and the address 176 from the user preferences file 158. Additionally, the identification module 142 may include operational instructions that when executed by the STB processor 132 cause the processor to retrieve the address 164 from the user preferences file 122 or to retrieve the address 176 from the user preferences file 158, where the address 164 or 176 is related to a network device, such as the network device 156, designated to receive the message 154. In a particular embodiment, the identification module 142 includes instructions executable by the STB processor 132 to determine an event type 168 or 180. The event type 168 may be retrieved from the user preferences file 122 or the event type 180 may be retrieved from the user preferences file 158. The identification module 142 also includes instructions executable by the STB processor 132 to identify one or more events of the event type 168 or 180 occurring within the time interval 166 or 178 at a media recorder. For example, the identification module 142 may include instructions executable by the STB processor 132 to identify one or more recording type events occurring within a designated twenty-four hour time interval at the media recorder 124.

The notification module 144 may include instructions executable by the STB processor 132 to send the message 154 to a network device, such as to the network device 156 via the public network 108. For example, when a subscriber requests the message 154 identifying events scheduled to occur at a media recorder 124 or 150 within the time interval 166 or 178, the notification module 144 may send the message 154 to the subscriber after the identification module 142 has identified the events scheduled within the time interval 166 or 178.

During operation, a subscriber may receive the message 154, notifying the subscriber of events scheduled at the media recorder 150 or the media recorder 124. The message 154 may be generated by the notification server 110 or by the notification module 144. Identifying events scheduled within a particular time interval at a media recorder and sending a message notifying a subscriber of the scheduled events may be performed in several different ways according to whether the media recorder is customer premises-based or network-based and according to whether the message is sent from the customer premises or from the network.

Events may be scheduled at the schedule of events 148 or 152 in response to recording requests or other subscriber requests. For example, a subscriber may use the remote control device 120 or the network device 156 to send the recording request 184 to the set-top box device 102, where the recording request 184 includes a specified time to schedule a recording of media content. To illustrate, the recording request 184 may include instructions to schedule a recording of “24” on Tuesday at 9:00 p.m. In response to receiving the request, the STB processor 132 may schedule recording of the show “24” on Tuesday at 9:00 p.m. at the schedule of events 148, causing a recording of the scheduled recording to be stored at the schedule of events 148.

In a particular embodiment, when events are scheduled at the media recorder 124 located at a customer's premises, the notification module 144 sends the message 154 to the network device 156 associated with the subscriber. In another embodiment, the notification server 110 sends the message 154 to the network device 156 associated with the subscriber. When the subscriber uses the network-based media recorder 150, the notification module 144 sends the message 154 to the network device 156 associated with the subscriber, or in another embodiment, the notification server 110 sends the message 154 to the network device 156 associated with the subscriber.

A subscriber may specify the time interval 166 or 178 and the address 164 or 176 to the set-top box device 102. For example, the subscriber may use the remote control device 120 to specify the time interval 166 or 178 and the address 164 or 176 via the remote interface 136. Additionally, the subscriber may use the network device 156 to specify time interval 166 or 178 and the address 164 or 176 via the network interface 130. The time interval 166 or 178 specifies a time period within which one or more recordings or events are scheduled to occur at the media recorder 124 or 150. The address 164 or 176 specifies where to send the message 154, such as a network address of the network device 156. In one embodiment, the set-top box device 102 may store the time interval 166 and the address 164 at the user preferences file 122. In a second embodiment, the set-top box device 102 may store the time interval 178 and the address 176 at the user preferences file 158. The user preferences file 122 or 158 enables the set-top box device 102 to retrieve the subscriber's preferences without having to repeatedly request the time interval and the network address from the subscriber.

In a particular embodiment, the identification module 142 retrieves the time interval 166 or 178 from a user preferences file, such as the user preferences file 122 or the user preferences file 158, to identify one or more scheduled events to occur within the time interval 166 or 178 based on the schedule of events 148. For example, the identification module 142 may search the schedule of events 148 for recordings that are scheduled to occur at the media recorder 124 within the time interval. To illustrate, the identification module 142 may identify the recording 160 scheduled to occur within a twenty-four hour period, based on the schedule of events 148 at the media recorder 124. As another example, the identification module 142 may identify scheduled events at the media recorder 150 that is located remote from the set-top box device 102. The identification module 142 may also retrieve the address 164 or 176 and send the message 154 to the subscriber using the address 164 or 176.

After the identification module 142 identifies events scheduled within the time interval 166 or 178, the notification module 144 may create the message 154 and send the message 154 to the subscriber's network address 164 or 176 identified in the user preferences file 122 or the user preferences file 158. The message may include the scheduling information 154 about all recordings or events scheduled to occur within a specified time interval at the media recorder 124 or the media recorder 150. In a particular embodiment, the message 154 is sent to a network device associated with the network address, such as the network device 156. For example, the network device 156 may be a computer or a portable network device, such as a phone, personal digital assistant (PDA), portable computer, portable gaming console, etc.

The message 154 may also include an advertisement 186 including one or more links to purchase products. The products may be selected at least partially based on media content of the one or more scheduled events. For example, when the message includes information that the shows “24” and “Lost” will be recorded at the media recorder 150 within a twenty-four hour period, the message may also include an advertisement to purchase products related to “24” and “Lost.” For example, the message may include links to purchase a digital video disc (DVD), compact disc (CD), or t-shirt related to the show “24” or related to movies starring one of the actors in the show “24.”

Further, the message 154 may include a link 157 to a remote application capable of remotely managing the scheduler module 140. For example, the message may include a link 157 to the remote application 114. The remote application 114 may enable the subscriber to use the network device 156 to add, delete, or modify an event, such as a recording, in the schedule of events 148 or the schedule of events 152.

In a particular embodiment, the notification server 110 sends the message 154 to a network address identifying one or more events scheduled to occur within a time interval at a media recorder. In another embodiment, the notification module 144 sends the message 154 to the network address identifying one or more events scheduled to occur within a time interval at a media recorder.

In a particular embodiment, the notification server 110 receives the message 154 including the scheduling information 155 identifying one or more events scheduled to occur within a time interval based on the schedule of events 148 at the media recorder 124. For example, the notification server 110 may receive the message 154 from the set-top box device 102 or from the media recorder 124 and may forward the message 154 to the network device 156. The notification server 110 may forward the message 154 or the notification server 110 may create the message 154 including scheduling information about the one or more events and send the message 154 to the address associated with the subscriber. For example, the notification server 110 may send the message 154 in the form of an email to the network device 156 belonging to a subscriber associated with the set-top box device 102.

The time interval 178 and the address 176 may have been previously received and stored at the notification server 110 before receiving the message 154. For example, the set-top box device 102 may have previously sent the address 176, the time interval 178, and the event type 180 to the notification server 110, which may have stored the time interval 178 and the address 176 at the user preferences file 158. In a particular embodiment, the notification server 110 retrieves the time interval 178 and the address 176 from the user preferences file 158 in response to receiving the message 154 including the one or more events scheduled to occur within the time interval. The notification server 110 may send the message 154 at the time 182 to the address 176, where the time 182 and the address 176 are specified by the subscriber. The scheduling information 155 may identify the one or more events scheduled to occur with the time interval 178.

For ease of explanation, the various modules 140-144 have been described in terms of processor-executable instructions. However, those skilled in the art will appreciate that such modules can be implemented as hardware logic, processor-executable instructions, or any combination thereof. In addition, although a single representative STB device 102 is illustrated, the system 100 may include any number of STB devices. As used herein, a STB device may be any device capable of receiving media content via a media content distribution network and capable of displaying or otherwise outputting media for display.

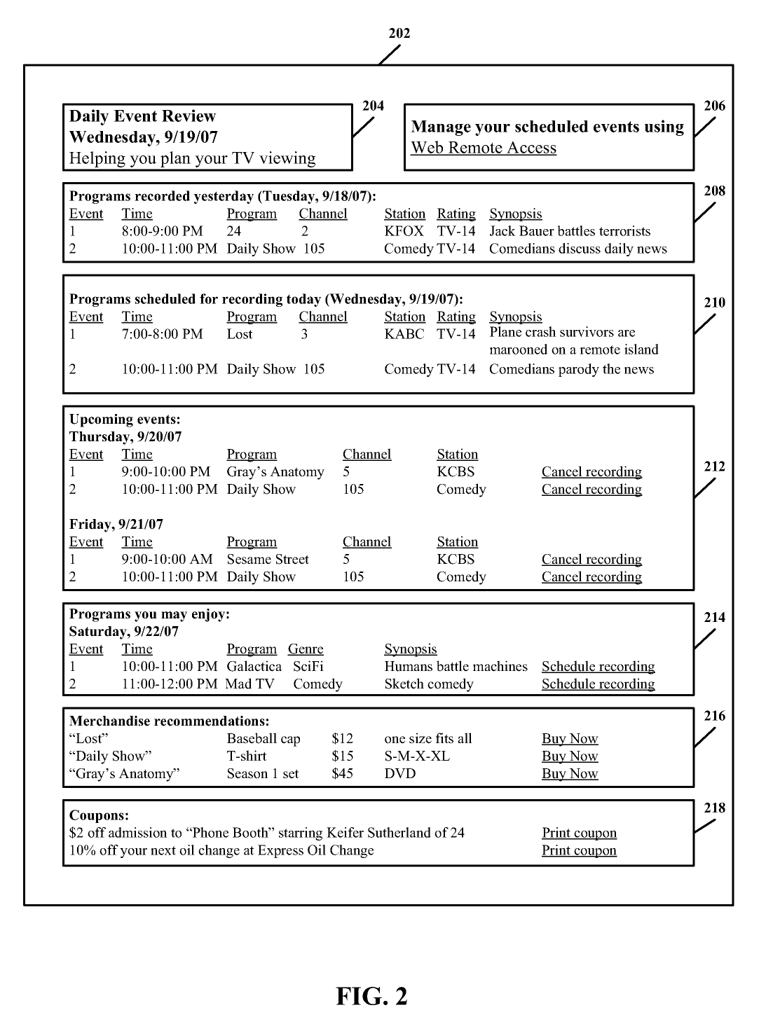

FIG. 2 is an illustrative embodiment of a graphical user interface display that may be displayed to a user of a media recorder, such as the media recorders 124 and 150 in FIG. 1. In an illustrative example, a device may send data used to display the graphical user interface display to the network device 156 of FIG. 1. The data used to display the graphical user interface display may be sent to a network device, such as the network device 156 of FIG. 1, from a device at the media content distribution network 104, such as the set-top box device 102, the notification server 110, or the media recorder 124 of FIG. 1.

The data used to generate the graphical user interface display 202 may be in the form of text, Hyper Text Markup Language (HTML), eXtensible Markup Language (XML), another format, or any combination thereof. The graphical user interface display 202 includes a header display area 204, which identifies content of the graphical user interface display 202. The header display area 204 may include a date of the displayed data, a time interval associated with the displayed data, and an explanation of the purpose of the displayed data.

The graphical user interface display 202 includes a management display area 206, which provides a link to an application for remotely managing a media recorder. For example, the management display area 206 may include a hyperlink to a remote access application. Selecting the hyperlink may cause the remote access application to execute on a remote computing device, such as the remote application 114 of FIG. 1. The remote access application may enable a subscriber to add, delete or modify a schedule of events, such as the schedule of events 148 or the schedule of events 152 of FIG. 1. The management display area 206 may include information related to shows, such as the channel, rating, station, synopsis, etc.

The graphical user interface display 202 includes a historical data display area 208. The historical data display area 208 may display information about one or more scheduled events that previously occurred at the media recorder. For example, the historical data display area 208 may display a listing of media content recorded during a previous time interval. The information about each recorded media content may include the start and end time, the name of the media content, the channel number, the station identifier, a rating, and a synopsis. In the example illustrated in FIG. 2, the historical data display area 208 indicates that the television shows “24” and the “Daily Show” were recorded during the previous twenty-four hour time interval. The historical data display area 208 may include information related to shows, such as the channel, rating, station, synopsis, etc.

The graphical user interface display 202 includes a scheduled event display area 210. The scheduled event display area 210 displays one or more events scheduled to occur within a time interval based on a schedule of events. For example, the scheduled event display area 210 may display recordings scheduled at a media recorder within a particular time interval. The information about each scheduled event may include the start and end time, the name of the event, the channel number at which the event is scheduled for broadcast, the station broadcasting the event, the rating of the event, and a synopsis of the event. In the example illustrated in FIG. 2, the scheduled event display area 210 indicates that the television shows “Lost” and “Daily Show” are scheduled for recording in the current twenty-four hour period. Other examples of a particular time period include mornings, afternoons, prime-time, late night, twelve hours, forty-eight hours, weekly, monthly, etc. The scheduled event display area 210 may include information related to shows, such as the channel, rating, station, synopsis, etc.

The graphical user interface display 202 includes an upcoming event display area 212. The upcoming event display area 212 displays one or more events scheduled to occur subsequent to the time interval based on the schedule of events at the media recorder. For example, the upcoming event display area 212 may identify one or more events scheduled to occur in the future, such as in the next one or more days, the next one or more weeks, or the next one or more months. The information about each upcoming event may include the start and end time of the upcoming event, the name of the upcoming event, the channel number at which the upcoming event is scheduled for broadcast, the station broadcasting the upcoming event, the rating of the upcoming event, and a synopsis of the upcoming event. In the example illustrated in FIG. 2, the upcoming event display area 212 displays the recordings scheduled for the next two twenty-four hour time intervals. The upcoming event display area 212 may also include a link to perform an action related to the upcoming event, such as cancel the recording of the upcoming event. The scheduled event display area 210 may include information related to shows, such as the channel, rating, station, synopsis, etc.

The graphical user interface display 202 includes a recommended media content display area 214. The recommended media content display area 214 may display one or more events that are not scheduled to occur but are recommended to the subscriber. For example, the recommended media content display area 214 may display events that are recommended based at least partially on the content of the scheduled events. The information about each recommended media content may include the start and end time, the name, the channel number, the station identifier, the rating, and a synopsis of the recommended media content. In the example illustrated in FIG. 2, “Galactica” is recommended based on an analysis that many subscribers who record “24” also record “Galactica,” and “Mad TV” is recommended based on an analysis that many subscribers who record the “Daily Show” also record “Mad TV.” The recommended media content display area 214 may include information related to shows, such as the channel, rating, station, synopsis, etc. The recommended media content display area 214 may also include a link to schedule recording of each of the recommended media content.

The graphical user interface display 202 includes an advertisement display area 216. The advertisement display area 216 may display an advertisement listing merchandise or services available for purchase. The merchandise or services may be selected at least partially based on the media content of the one or more scheduled events. In the example illustrated in FIG. 2, merchandise related to the television shows “Lost,” the “Daily Show,” and “Gray's Anatomy” is advertised because those television shows are scheduled for recording. The advertisement display area 216 may include information about the merchandise, such as a description and price information, and may also include other links to purchase each of the merchandise or services displayed.

The graphical user interface display 202 includes a coupon display area 218. The coupon display area 218 may display a link to access coupons, video-on-demand content, interactive content, other content, or any combination thereof. A link to coupons may be selected based at least partially on media content of the one or more scheduled events. In the example illustrated in FIG. 2, the coupon display area 218 displays a link to a coupon for the movie “Phone Booth” because one of the actors in “Phone Booth,” Keifer Sutherland, is also an actor on the show “24” which is scheduled for recording. The link to coupons may be selected based at least partially on a location of the subscriber. Further, in the example illustrated in FIG. 2, the coupon display area 218 displays a link to access a coupon for an oil change at an Express Oil Change located near the subscriber. The location of the subscriber may be determined based on a physical address of the subscriber's set-top box device or based on a location of the subscriber's portable network device, such as the subscriber's cell phone, and the coupon may be selected based partially on the location of the cell phone.

The data used to generate the graphical user interface display 202 may be sent from a notification server to a subscriber's network device after the notification server receives the data from a set-top box associated with a media recorder. For example, in the system 100 of FIG. 1, the set-top box 102 associated with the media recorder 124 may send data to generate the graphical user interface display 202 to the notification server 110, and the notification server 110 may send the data to the network device 156.

In another embodiment, the data used to generate the graphical user interface display 202 is sent from a set-top box device to a network device. For example, in FIG. 1, the set-top box device 102 may send data to the network device 156, and the network device 156 may display the data as the graphical user interface display 202.

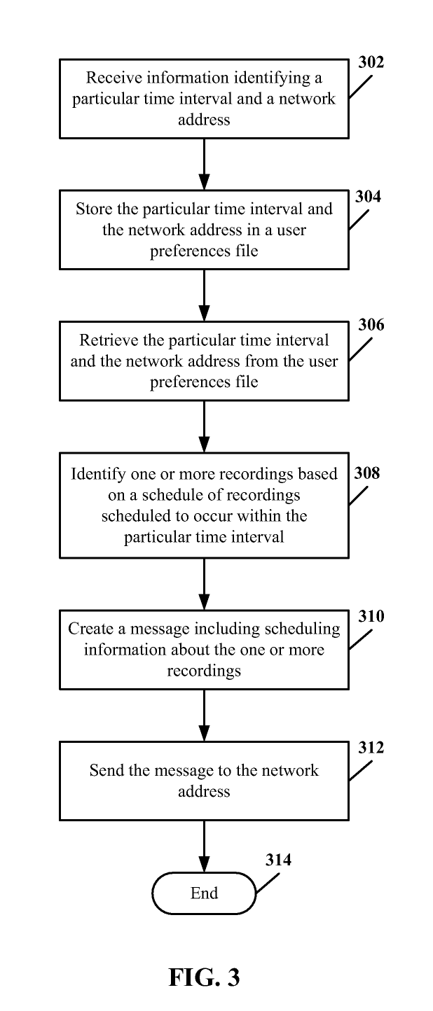

FIG. 3 is a flow diagram of a first particular embodiment of a method of identifying events scheduled at a media recorder, such as the media recorders 124 and 150 in FIG. 1. In a particular embodiment, one or more modules at a set-top box, such as the set-top box device 102 of FIG. 1, may execute the method. At 302, information identifying a particular time interval and a network address is received. In an illustrative embodiment, a time interval and a network address are received from a subscriber via input from a remote control or from a network device. In another illustrative embodiment, the time interval and the network address are received from a notification server. The network address may be an address of a network device or a communication address associated with the subscriber, such as an email address, short message service address, etc. The time interval may be any interval of time, such as four hours, eight hours, twelve hours, twenty-four hours, a week, other time interval or any combination thereof.

Moving to 304, the particular time interval and the network address is stored at a user preferences file. The user preferences file may be stored at a network device, a network server, a set-top box device, a media recorder, or another device. The user preferences file may also include information related to notifying a subscriber about events scheduled at a media recorder. The user preferences file enables the subscriber to specify his or her preferences once, after which the subscriber's preferences may be periodically retrieved and, based on the retrieved preferences, a notification may be sent to the subscriber. Advancing to 306, the particular time interval and the network address may be retrieved from the user preferences file. Proceeding to 308, one or more recordings are identified based on a schedule of recordings scheduled to occur within the particular time interval. The schedule of recordings includes data specifying media content to be recorded by the media recorder. The schedule of recordings may indicate a recording time period during which the media content is to be recorded. The recordings are identified to occur within the time interval when all or a portion of a recording time period associated with the recording is within the time interval.

Advancing to 310, a message is created that includes scheduling information about the one or more recordings. The message may include data to generate a graphical user interface display, such as the graphical user interface display of FIG. 2. Moving to 312, the message is sent to the network address, where the network address is associated with a network device that is remote from the media recorder. A module, such as the notification module 144, or a server, such as the notification server 110 of FIG. 1, may send the message. The method then ends at 314.

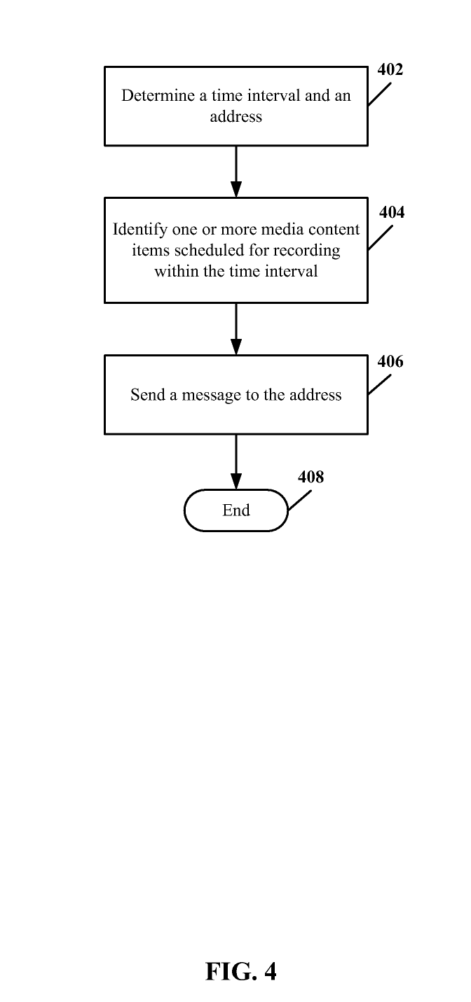

FIG. 4 is a flow diagram of a second particular embodiment of a method of identifying events scheduled at a media recorder, such as the media recorders 124 and 150 in FIG. 1. One or more modules at a set-top box, such as the set-top box device 102 of FIG. 1, may execute the method. At 402 a time interval and an address are determined. For example, the time interval, the address, and an event type may be received via a user input or by retrieving them from a user preferences file. The user preferences file may be accessible to a set-top box device or to a notification server. Moving to 404, one or more media content items scheduled for recording within the time interval are identified. For example, when the event type is a recording and the time interval is twenty-four hours, all recordings scheduled within a twenty-four hour period are identified. Proceeding to 406, a message is sent to the address. The message includes information, such as scheduling information, about the one or more recordings scheduled within the time interval. The information may be used to generate the graphical user interface display 202 of FIG. 2. The method ends at 408.

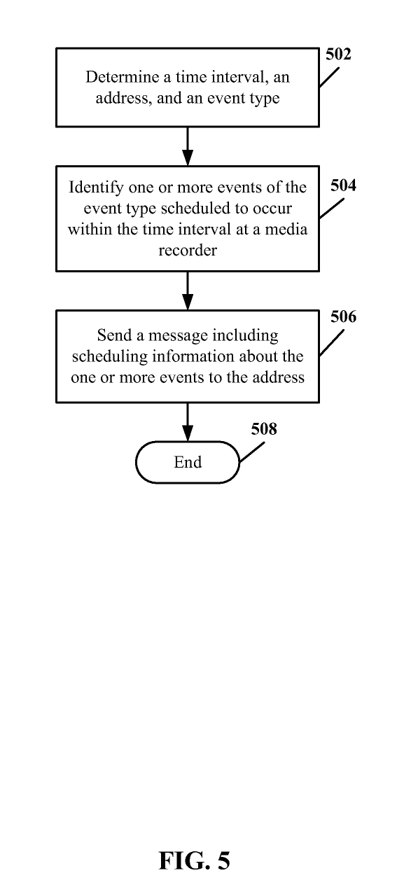

FIG. 5 is a flow diagram of a third particular embodiment of a method of identifying events scheduled at a media recorder, such as the media recorders 124 and 150 in FIG. 1. One or more modules at a set-top box, such as the set-top box device 102 of FIG. 1, may execute the method. At 502, a time interval, an address, and an event type are determined. In an illustrative embodiment, the time interval, the address, and the event type are received from a network device associated with a subscriber. In another illustrative embodiment, the time interval, the address, and the event type are retrieved from a user preferences file. Each event may be classified based on an event type. The event type may correspond to one or more categories of events scheduled at a media recorder, such as a recording, a notification, a media transfer, one or more other types of actions capable of being performed by a media recorder, or any combination thereof. In one example, the media recorder may send a notification to a subscriber just before media content is scheduled for transmission. In another example, the media transfer may include transferring a recording from one media format to another media format. To illustrate, the media recorder may transfer a recording at a hard drive media, to an optical disc media.

Moving to 504, one or more events of the event type scheduled to occur within the time interval at a media recorder are identified. For example, when the event type is a recording, all recordings scheduled to occur at the media recorder within the time interval are identified. Proceeding to 506, a message including scheduling information about the one or more events is sent to the address. The message may include information used to generate the graphical user interface display 202 of FIG. 2. The address may be the address of a network device associated with the subscriber, such as an email address, telephone number, other address associated with a network device, or any combination thereof. The scheduling information may include the media content type, a channel identifier at which the media content may be received, the length of the media content transmission, a synopsis of the media content, other information related to the media content, or any combination thereof. The method ends at 508.

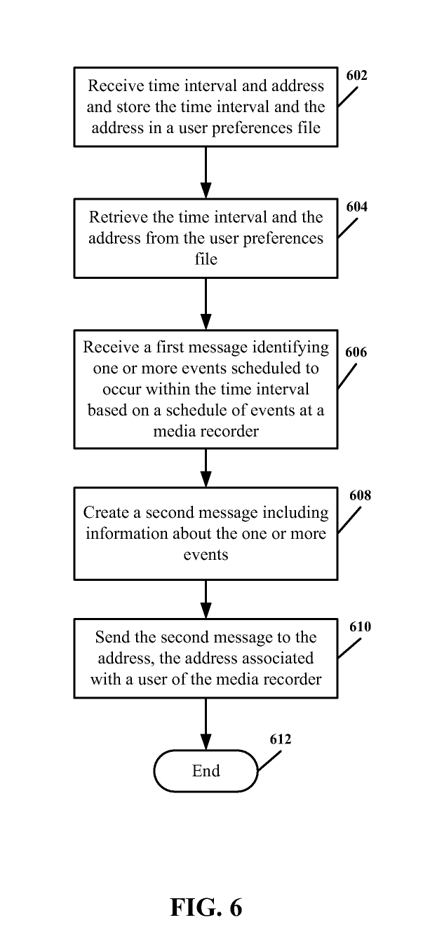

FIG. 6 is a flow diagram of a fourth particular embodiment of a method of identifying events scheduled at a media recorder, such as the media recorders 124 and 150 in FIG. 1. A notification server, such as the notification server 110 of FIG. 1, may execute the method. At 602, a time interval and an address are received and the time interval and the address are stored in a user preferences file. For example, the notification server 110 may receive the time interval and the address via the remote control device 120 or via the network device 156 of FIG. 1. The notification server 110 may store the time interval and the address in the user preferences file 158. The address may be an email address or a telephone number.

Advancing to 604, the time interval and the address are retrieved from the user preferences file. For example, the notification server 110 may retrieve the address and the time interval from the user preferences file 158 of FIG. 1. The user preferences file enables the subscriber to specify his or her preferences once, after which the subscriber's preferences may be periodically retrieved and, based on the retrieved preferences, a notification may be sent to the subscriber.

Proceeding to 606, a first message is received identifying one or more events scheduled to occur within the time interval based on a schedule of events at a media recorder. For example, the notification server 110 may send a message to the set-top box device 102 requesting information about the one or more events scheduled to occur within the time interval. The set-top box device 102 may determine the one or more events scheduled to occur within the time interval at the media recorder 124 based on the schedule of events 148. The notification server 110 may receive a message from the set-top box device 102 identifying one or more events scheduled to occur within the time interval.

Continuing to 608, a second message is created including information about the one or more events scheduled to occur within the time interval. For example, the information may be used to generate the graphical user interface display 202 of FIG. 2. Proceeding to 610, the message is sent to the address, where the address is associated with a user of the media recorder. For example, the notification server 110 may send the message to a phone number or email address associated with a user of the media recorder 124. The phone number or email address may be the address of the network device 156. The method ends at 612.

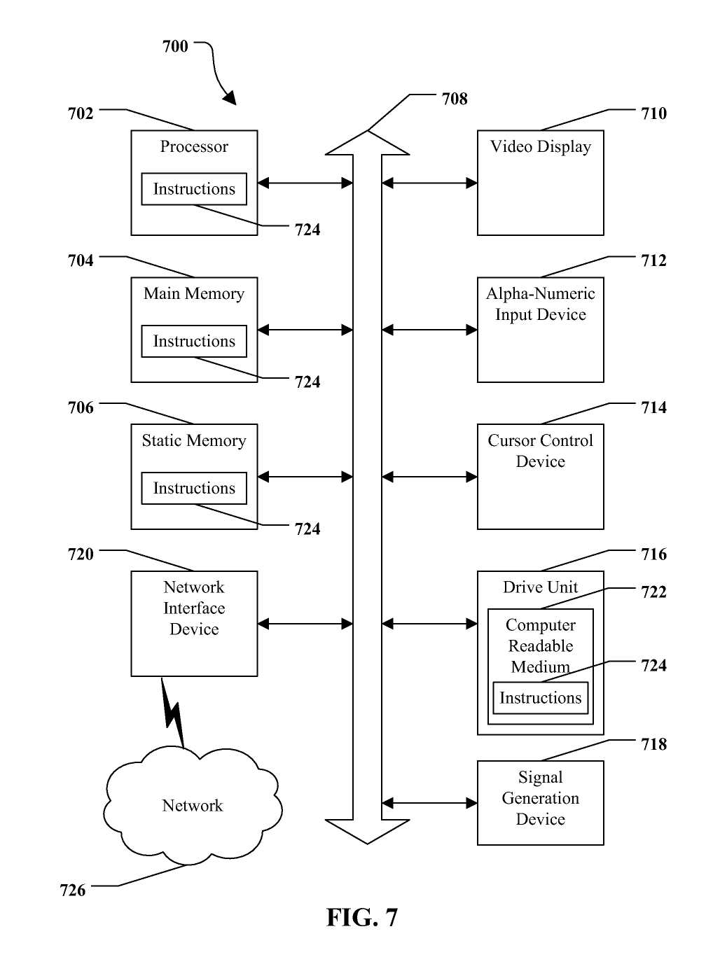

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, including a notification server, a media content server, an electronic program guide (EPG) server, a remote application server, a network device, or a set-top box device, as shown in FIG. 1.

In a networked deployment, the computer system may operate in the capacity of a media content distribution network server, such as a video server or application server, or a set-top box device. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid-state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of identifying events scheduled at a media recorder, the method comprising:
identifying one or more recordings scheduled to occur at the media recorder within a particular time interval;
creating a message including scheduling information related to the one or more recordings; and
sending the message to a network address, the network address associated with a network device remote from the media recorder.

2. The method of claim 1, further comprising:
receiving information identifying the particular time interval and the network address; and
storing the particular time interval and the network address in a user preferences file prior to identifying the one or more recordings.

3. The method of claim 1, further comprising retrieving the particular time interval and the network address from a user preferences file prior to identifying the one or more recordings.

4. The method of claim 1, wherein the network address is associated with a portable communication device.

5. The method of claim 4, wherein the portable communication device is one of a mobile phone, a personal digital assistant, and a music player.

6. The method of claim 1, wherein the message includes an advertisement selected at least partially based on media content of the one or more recordings.

7. The method of claim 1, wherein the media recorder is a network-based media recorder having access to a media content distribution network.

8. A method at a notification server, the method comprising:
receiving a first message, the first message identifying one or more events scheduled to occur at a media recorder within a time interval based on a schedule of events;
creating a second message including information about the one or more events; and
sending the second message to an address associated with a device of a user of the media recorder.

9. The method of claim 8, wherein the second message includes a recommendation of media content selected at least partially based on the media content of the one or more events.

10. The method of claim 9, wherein the second message includes a link to execute a transaction associated with the recommendation of media content.

11. The method of claim 10, wherein the transaction is one of purchasing the media content and renting the media content.

12. A system, comprising:
an identification module to determine a time interval and an address and to identify one or more media content items scheduled for recording within the time interval; and
a notification module to send a message to the address, the message including scheduling information related to the one or more media content items scheduled for recording within the time interval.

13. The system of claim 12, further comprising a scheduler module to receive at least one recording request that includes a specified time to record the one or more media content items.

14. The system of claim 13, wherein the scheduler module is further adapted to schedule a recording of at least one of the one or more media content items at the specified time.

15. The system of claim 14, wherein the message includes a link to a remote application that is adapted to remotely manage the scheduler module.

16. A computer-readable storage medium, comprising:
operational instructions, that when executed by a processor, cause the processor to determine a time interval, an address, and an event type, the event type comprising at least one of a recording, a notification, and a media transfer;
operational instructions, that when executed by the processor, cause the processor to identify one or more events of the event type, wherein the one or more events are scheduled to occur within the time interval at a media recorder; and
operational instructions, that when executed by the processor, cause the processor to send a message to the address, the message including scheduling information related to the one or more events.

17. The computer-readable storage medium of claim 16, wherein the message further includes a media content recommendation based at least partially on media content of the one or more events.

18. A graphical user interface display at a portable communication device, the graphical user interface display comprising:
a scheduled event display area to display one or more recordings scheduled to occur at a media recorder within a time interval based on a schedule of events at the media recorder;
wherein the media recorder is remote from the portable communication device.

19. The graphical user interface display of claim 18, further comprising an upcoming event display area to display one or more events scheduled to occur outside the time interval at the media recorder.

20. The graphical user interface display of claim 18, further comprising a historical data display area to display one or more previously scheduled events that occurred at the media recorder.

21. The graphical user interface display of claim 18, further comprising a recommended media content display area to display one or more media content recommendations selected at least partially based on media content of the one or more recordings.

22. The graphical use interface display of claim 21, wherein the recommended media content display area includes a link to perform a transaction associated with the one or more media content recommendations.

23. The graphical user interface display of claim 18, further comprising an advertisement display area to display an advertisement selected at least partially based on media content of the one or more scheduled recordings.

24. The graphical use interface display of claim 23, wherein the advertisement display area includes a link to execute a transaction associated with a product indentified by the advertisement.

25. The graphical user interface display of claim 18, further comprising a coupon display area to display one or more coupons, the one or more coupons selected based at least partially on at least one of media content of the one or more scheduled events and a location of the portable communication device.
